(19) United States
(12) Patent Application Publication
(10) Pub. No.: US 2007/0143064 A1
(43) Pub. Date: Jun. 21, 2007

(54) Detached remote sensor detection

(75) Inventors: Colm Boran, Novi, MI (US); Oscar Angel JR., Farmington Hills, MI (US); Richard Rakes JR., Milan, MI (US)

Correspondence Address: AUTOLIV ASP, 3350 AIRORT ROAD, OGDEN, UT, 84405, US

(73) Assignee: Autoliv ASP, Inc.

(21) Appl. No.: 11/313,471

(22) Filed: Dec. 20, 2005

(51) Int. Cl. G01P 15/00; G01L 3/00; G01D 18/00; E05F 15/00; G08B 23/00; G08B 21/00; B60Q 1/00

(52) U.S. Cl. 702/141; 702/41; 702/104; 701/45; 340/501; 340/669; 340/436

(57) ABSTRACT

A system includes a remote sensor and an electronic control unit. The electric control unit determines if the remote sensor is detached from the vehicle structure by analyzing the sensor signal from the remote sensor. The electronic control unit may compare the sensor signal to other signals. For example, from another remote sensor or an on-board sensor contained within the electronic control unit. The electronic control unit identifies features in the sensor signal indicative of the remote sensor being detached from the vehicle.

### BACKGROUND OF THE INVENTION

1. Field of the Invention

The present invention generally relates to a system which determines when a sensor is no longer in a mounted state securely attached to the structure of a vehicle.

2. Description of Related Art

Vehicle safety systems often use sensors that are located remotely from a centralized electronic control unit. Remote sensors are often located around the periphery of the vehicle and other locations to provide local information prior to and during impact. The sensed information can be used to alert the driver or deploy or operate safety systems. For example, accelerometers can provide information regarding inertial forces acting on the car prior or during impact and the severity of the impact. While the vehicle is being driven, the remote sensors continuously provide acceleration and other data to the centrally located electronic control unit. Other types of sensors can measure deflection or deformation of a vehicle component or structure. Typically, the remote sensors are in electrical communication with the electronic control unit via a wire harness. The remote sensor is securely attached to the body of the vehicle through a mechanical coupling. The mechanical coupling must be designed to properly couple the sensor to the structure so that the rate of deceleration of the surrounding vehicle structure or other physical parameters can be accurately sensed. If the sensor becomes detached from the vehicle structure, an incorrect measurement of the crash characteristics or other physical parameter may result. Therefore, it is desirable to detect if a remote sensor is detached from the vehicle structure to ensure proper performance of vehicle systems including safety systems.

One known system determines if the sensor is detached by using the sensor contact with the vehicle structure to provide an electrical ground to the sensor. The electrical ground signal from the sensor may be compared to a known grounded wire in the wiring harness. The electrical potential between the sensor ground signal and the wiring harness ground signal is therefore indicative of the sensor's mount to the vehicle structure. However, this method requires an electrical path between the sensor and the vehicle sheet metal ground, preventing the use of non-conductive packages. Additionally, vehicles are often exposed to harsh environmental conditions. Accordingly, corrosion or other environmental factors may affect the integrity of the electrical connection between the sensor and the vehicle structure. In addition, the sensor would be exposed to the electrical noise introduced to the vehicle structure by the battery or other means. Further, the presence of electrical grounding does not necessarily reflect the structural integrity of the sensor mounting.

In view of the above, it is apparent that there exists a need for an improved system for determining if a sensor is detached from the structure of the vehicle.

### SUMMARY OF THE INVENTION

In satisfying the above need, as well as overcoming the enumerated drawbacks and other limitations of the related art, the present invention provides a system that analyzes the data collected from a sensor to determine if that sensor is detached from the vehicle structure.

The system includes a remote sensor and an electronic control unit. The electronic control unit determines if the remote sensor is detached from the vehicle structure by analyzing the sensor signal from the remote sensor. The electronic control unit may compare the sensor signal to other signals, such as signals from another remote sensor or an on-board sensor contained within the electronic control unit to identify differences in the sensor signals. For example, when the sensor is detached, it often intermittently contacts a nearby vehicle structure or vibrates due to typical motion of the vehicle. Accordingly, the accelerometer in the remote sensor measures minor transient signals, for example spikes, of acceleration due to the bumping or vibration. As the electronic control unit actively monitors the sensor signal from the remote sensor, it processes the data through a software algorithm to identify transient signals caused by the intermittent contact. The sensor signal is then compared to other sensors to determine if the minor impacts, in the form of acceleration, transient signals are isolated to that particular remote sensor or if the transient signals are a byproduct of road noise measured to some degree by multiple sensors of the system.

By using the software algorithm to determine if the sensor is detached, greater packaging flexibility is provided to the remote sensor. The additional packaging flexibility is available because the sensor no longer requires a metallic or conductive coupling surface to provide an electrical connection with the vehicle structure, required where such grounding is used to evaluate proper mounting. In addition, the sensor has improved immunity to the harsh automotive environment because water ingress and corrosion can be reduced, since electrical contact does not need to be maintained between the housing and an internal circuit board of the remote sensor. In addition, the reliability of the remote sensor is improved and false detections are reduced, because vehicle ground voltage fluctuations are not introduced into the remote sensor system by electromagnetic noise carried in the vehicle structure. Further, less hardware is required for the sensor detachment detection, thereby reducing material costs and simplifying the overall system.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system for measuring vehicle characteristics in accordance with the present invention;

FIG. 2 is a plan view of a sensor properly attached to the vehicle structure;

FIG. 3 is a plan view of a detached sensor impacting the vehicle structure; and

FIG. 4 is a graph illustrating multiple sensor signals that may be used to determine if the sensor is detached in accordance with the present invention.

### DETAILED DESCRIPTION OF THE INVENTION

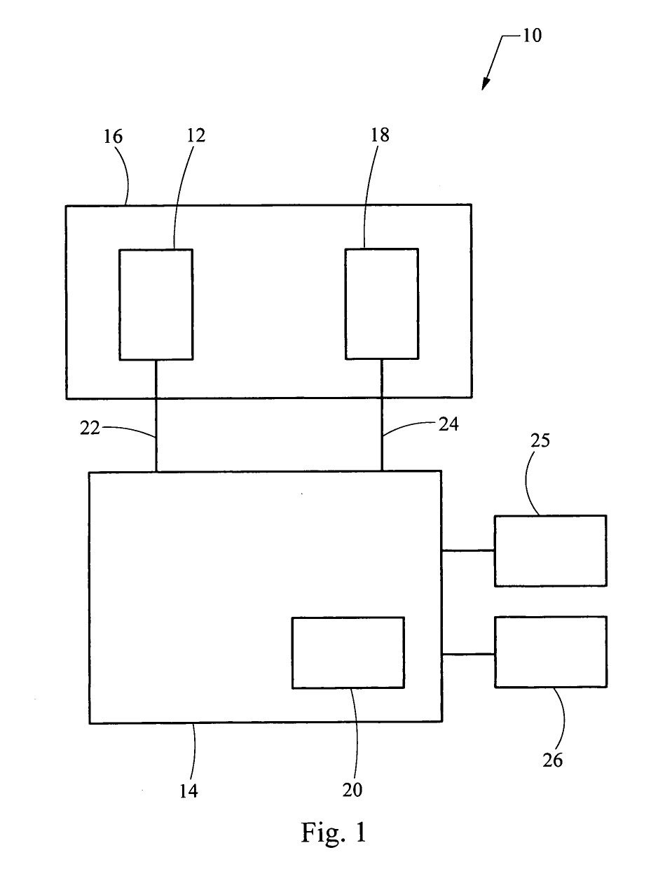

Referring now to FIG. 1, a system embodying the principles of the present invention is illustrated therein and designated at 10. The system 10 includes a sensor 12 and an electronic control unit 14. The sensor 12 is in electrical communication with the electronic control unit 14, through a wire harness 22, to provide a sensor signal indicative of vehicle characteristics. For example, the sensor 12 may be an accelerometer to provide information for a vehicle safety system prior to or during crash conditions. Accordingly, the sensor 12 is a remote sensor that is coupled to the vehicle structure 16 at a position away from the electronic control unit 14. The sensor 12 may be mounted on the vehicle structure 16 through any common attachment means including fasteners such as bolts, clips, or rivets, or through bonding such as welds or adhesive. As such, the remote sensor 12 may receive local information earlier than other sensors or in a different magnitude than other sensors located at other locations mounted to the vehicle. Further, a second sensor 18 is also mounted on and attached to the vehicle structure 16 at another location on the vehicle. The second sensor 18 is also in electrical communication with the electronic control unit 14, through a wire harness 24, to provide a sensor signal. In addition, the electronic control unit 14 may include an on-board sensor 20, such as an accelerometer to provide general vehicle acceleration information.

The electronic control unit 14 is also in electrical communication with a safety system 25, such as a frontal or side impact airbag, belt pre-tensioner, or other safety system. The electronic control unit 14 is configured to modify safety system characteristics if the electronic control unit 14 determines the remote sensor 12 is detached from the vehicle structure 16. In addition, the electronic control unit 14 is in electrical communication with a vehicle information system 26 to provide a signal indicating the remote sensor 12 is detached from the vehicle structure 16. As such, the vehicle information system 26 can alert the driver or service person regarding the fault condition. For example, an audible alert such as a chime, a visual alert such as a warning light, or an information message on a vehicle text display may be provided to warn the driver or service person.

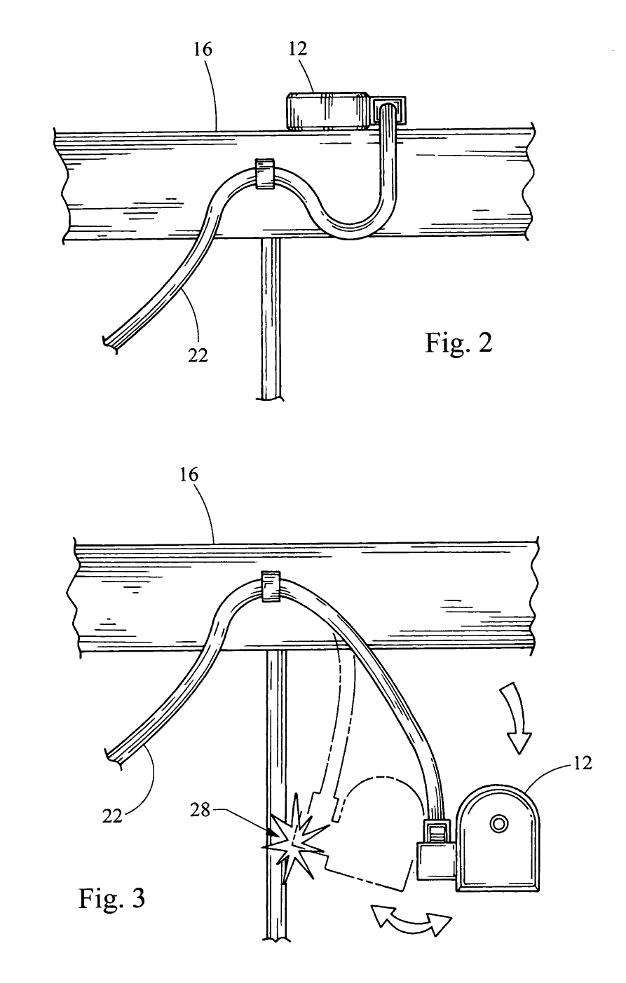

Now referring to FIG. 2, the sensor 12 is attached to the vehicle structure 16 shown as a section of the vehicles rocker panel and should be securely fixed in three dimensions to constrain orientation, as well as, location of the sensor 12 relative to the structure 16. FIG. 2 shows sensor 12 in the desired constrained state, being properly mounted to, and structurally coupled with structure 16. As previously discussed, the sensor 12 may be mounted on the structure 16 using any common attachment means to fix the sensor 12 relative to the structure 16. In addition, a wiring harness 22 provides the electrical connection between the sensor 12 and the electronic control unit 14. To provide strain relief for the wire harness 22, the wire harness 22 is generally not taut near the sensor 12 and, therefore, may be also attached to the structure 16 via clips or other methods. Due to the harsh vehicle environment including changes in temperature, as well as, vibration or even errors in manufacturing, the mechanical coupling between the sensor 12 and the structure 16 may become compromised allowing movement between the sensor 12 and the structure 16, as shown in FIG. 3. Thus, FIG. 3 shows an undesirable second state not being properly mounted to and structurally coupled with structure 16. When detached from the vehicle structure 16, the sensor 12 may be allowed to move freely about a compartment within the vehicle structure 16 such as in the closed box section of the rocker panel, or inside a side door. For example, the sensor 12 may only be constrained based on its attachment to the electrical wiring harness 22. The motion of the vehicle will cause the sensor 12 to swing back and forth relative to the structure 16. Further, the sensor 12 may impact the vehicle structure as denoted by reference numeral 28. The impact 28 will be sensed by the sensor 12 as a change in acceleration and not sensed by sensor 18 and sensor 20. Accordingly, the impact 28 will form transient signals, for example spikes, in the sensor signal that are provided to the electrical control unit 14.

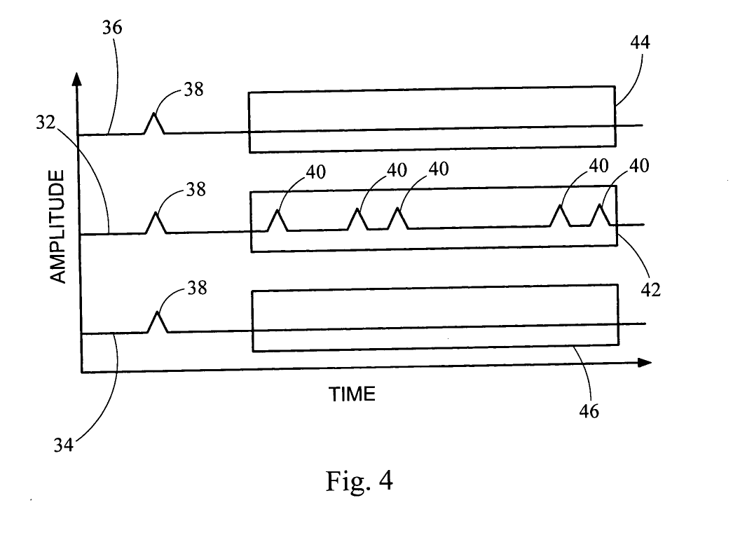

Now referring to FIG. 4, a graph is provided showing multiple sensor signals from the various sensors of the system 10. Signal 32 corresponds to the sensor signal from sensor 12. Similarly, reference numeral 34 corresponds to the sensor signal from remote sensor 18, and sensor signal 36 corresponds to the on-board sensor 20 contained within the electronic control unit 14. The sensor signals 32, 34, 38, relate to changes in acceleration applied to the structure 16. A global impact such as road noise will be seen as a transient signal on multiple sensors as denoted by reference numeral 38. However, if the sensor 12 is not constrained relative to the structure 16, the sensor 12 may be involved in local impacts causing features, such as transient signals, in the detached sensor as denoted by reference numeral 40. The features in the sensor signal can be analyzed based on the amplitude, frequency, or other feature characteristics to identify that the sensor is not in the mounted state. As such, the electronic control unit 14 may determine the state of the sensor 12 by the sensor signal of sensor 12 alone or in reference to another sensor signal. Accordingly, the electronic control unit 14 compares the sensor signal 32 of the sensor 12 to the sensor signal of other sensors. The comparison is used to determine whether the movement of sensor 12 is in the constrained state associated with it properly mounted and structurally coupled to the vehicle structure 16. If the sensor 12 is not in the above-described constrained state, the sensor 12 may be impacting the vehicle structure 16 causing corrupted data. As such, the electronic control unit 14 may analyze the signal 32 to identify transient signals 40 indicative of the sensor 12 being in a state other than the constrained state. Further, the electronic control unit 14 may identify particular transient signals as being candidates for local impacts based on the frequency, amplitude, and/or slope of the transient signals 40. Then, the electronic control unit 14 may compare the sensor signal 32 for a given time window 42 to other sensor signals and their corresponding time windows. For example, the sensor signal 32 over the time window 42 may be compared with the sensor signal 36 for a corresponding time window 44, thereby comparing the sensor signal of sensor 12 to on-board sensor 20 of the electronic control unit 14. In addition, the electronic control unit 14 may compare the sensor signal 32, over the time window 42, to a sensor signal 34 from a remote sensor 18, over a corresponding time window 46.

The comparison may be based on a subtraction of the sensor signal 32 for remote sensor 12 from the sensor signal of another sensor. For example, the sensor signal 32 can be aligned with sensor signal 34 based on the corresponding time windows or by some feature in the signals. In addition, sensor signal 32 may be scaled in either the time dimension or in amplitude to better correspond to sensor signal 34 prior to the subtraction. The sensor signal 32 may then be subtracted from sensor signal 34 and the resulting data analyzed to determine if the transient signals are indicative of a sensor in a state other than the constrained state.

Alternatively, transient signals may be identified by their time and amplitude. The time and amplitude of particular transient signals may be matched to a corresponding time within the sensor signal of one of the other sensors. This may be easily accomplished applying a threshold to the sensor signal 32 to identify the peaks 40. Then, a second threshold is applied to another sensor signal, for example signal 34, to determine if peaks occur in a substantially similar time and manner.

The electronic control unit 14 may disregard or compensate for the corrupted data of the remote sensor 12, if it is determined that the remote sensor 12 is not properly constrained relative to the vehicle structure 16. Accordingly, the electronic control unit 14 may adjust deployment parameters for a safety system 25 such as an airbag, belt tensioners, evasive suspension system, or other commonly used safety systems based on the determination that the remote sensor 12 is detached. In addition, the electronic control unit 14 may provide a signal to a vehicle information system 26 to provide an audible alert such as a chime, a visual alert such as a warning light, or an information message on a vehicle text display to warn the driver or service person.

As a person skilled in the art will readily appreciate, the above description is meant as an illustration of the principles this invention. This description is not intended to limit the scope or application of this invention in that the invention is susceptible to modification, variation and change, without departing from spirit of this invention, as defined in the following claims.

We claim:

1. A system for determining characteristics of a motor vehicle, the system comprising:
a first sensor adapted for attachment to the vehicle in a first mounted state that constrains movement of the sensor relative to the vehicle, and the first sensor being configured to generate a first signal;
an electronic control unit in electrical communication with the first sensor for receiving the first signal, the electronic control unit being configured determine if the first sensor is in a second state that is less constrained relative to the vehicle than the first mounted state, based on features in the first signal.

2. The system according to claim 1, wherein the first sensor is an acceleration sensor.

3. The system according to claim 1, wherein the electronic control unit is configured to compare the first signal to a second signal.

4. The system according to claim 3, wherein the second signal is generated from a second sensor.

5. The system according to claim 4, wherein the second sensor is an on-board accelerometer in the electronic control unit.

6. The system according to claim 4, wherein the second sensor is a remote sensor attached to the structure of the vehicle.

7. The system according to claim 3, wherein the electronic control unit is configured to threshold the second signal in regions corresponding to the features in the first signal.

8. The system according to claim 3, wherein the electronic control unit is configured to subtract a portion of the first signal contained in a first time window from a portion of the second signal in a corresponding time window.

9. The system according to claim 1, wherein the features are identified based on the amplitude of the first sensor signal.

10. The system according to claim 1, wherein the features are identified based on the slope of the first sensor signal.

11. The system according to claim 1, wherein the features are identified based on the frequency of the first sensor signal.

12. The system according to claim 1, wherein the electronic control unit is configured to activate a sensor error alarm based on the features.

13. The system according to claim 1, wherein the electronic control unit is configured to modify deployment characteristics of a safety system based on the features.

14. A system for determining characteristics of a motor vehicle, the system comprising:
a first sensor adapted for attachment to the vehicle in a first mounted state that constrains movement of the first sensor relative to the vehicle, and the first sensor being configured to measure a first acceleration signal;
an electronic control unit in electrical communication with the first sensor for receiving the first acceleration signal, the electronic control unit being configured to perform a comparison between at least one transient signal in the first acceleration signal and a second acceleration signal, the electronic control unit being adapted to determine if the first sensor is in a second state that is less constrained relative to the vehicle than the first mounted state, based on the comparison.

15. The system according to claim 14, wherein the transient signal comprises a spike in the first acceleration signal.

16. The system according to claim 14, wherein the second acceleration signal is generated from a second sensor.

17. The system according to claim 14, wherein the second sensor is an on-board accelerometer in the electronic control unit.

18. The system according to claim 14, wherein in the electronic control unit is configured to threshold the second acceleration signal in regions corresponding to the at least one transient signal.

19. The system according to claim 14, wherein the electronic control unit is configured to activate a sensor error alarm based on the comparison.

20. The system according to claim 14, wherein the electronic control unit is configured to modify safety system deployment characteristics based on the comparison.
